(19) United States
(12) Patent Application Publication
(10) Pub. No.: US 2006/0004856 A1
(43) Pub. Date: Jan. 5, 2006

(54) Data management and persistence frameworks for network management application development

(76) Inventors: Xiangyang Shen, Naperville, IL (US); Edward G. Brunell, Chicago, IL (US); Shankar Krishnamoorthy, Scotch Plains, NJ (US); Manjula Sridhar, Lisle, IL (US); Dong Zhao, Lisle, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/868,217

(22) Filed: Jun. 15, 2004

(51) Int. Cl. G06F 17/00

(52) U.S. Cl. 707/103 Y

(57) ABSTRACT

Methods of developing an application program to manage a distributed system or network are provided. In one embodiment, the method includes: a) defining managed objects in a resource definition language and storing the definition in resource definition language files, b) parsing the resource definition language files to ensure conformity with the resource definition language and creating an intermediate representation of the distributed system, c) processing the intermediate representation to form programming language classes, database definition files, and script files, d) developing a reusable asset center framework to facilitate development of the application program, the reusable asset center including a data management framework that provides creation, deletion, modification, and browsing functions and/or a persistence framework that provides persistent data storage functions in conjunction with the managed objects and the database, and e) building the application program from the programming language classes, database definition files, script files, and the reusable asset framework.

### CROSS-REFERENCE TO RELATED APPLICATIONS

This application is related to Zhao et al., Attorney Docket No. LUTZ 2 00268 and Lucent Case Name/No. Brunell 1-1-1-1-1, entitled “Run-Time Tool for Network Management Application,” filed Jun. 15, 2004, commonly assigned to Lucent Technologies, Inc. and incorporated by reference herein.

This application is related to Sridner et al., Attorney Docket No. LUTZ 2 00289 and Lucent Case Name/No. Brunell 2-2-2-2-2, entitled “Resource Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00324 and Lucent Case Name/No. Brunell 3-3-3-3-3, entitled “View Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00323 and Lucent Case Name/No. Brunell 4-1-4-4-4-4, entitled “Distribution Adaptor for Network Management Application Development,” filed Jun. 15, 2004, commonly assigned to Lucent Technologies, Inc. and incorporated by reference herein.

This application is related to Zhao et al., Attorney Docket No. LUTZ 2 00325 and Lucent Case Name/No. Brunell 5-2-5-5-5, entitled “Event Management Framework for Network Management Application Development,” filed Jun. 15, 2004, commonly assigned to Lucent Technologies, Inc. and incorporated by reference herein.

This application is related to Sridner et al., Attorney Docket No. LUTZ 2 00326 and Lucent Case Name/No. Brunell 6-1-6-5-6-6, entitled “Managed Object Framework for Network Management Application Development,” filed Jun. 15, 2004, commonly assigned to Lucent Technologies, Inc. and incorporated by reference herein.

This application is related to Sridner et al., Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to a reusable asset center (RAC) framework in a development environment for network management applications and, more particularly, to a data management framework (DMF) and a persistence framework (PF) within the RAC framework for providing the network management applications with a core framework for managing object representations associated with the network.

While the invention is particularly directed to the art of network management application development, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN.1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN.1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN.1 macro, TEXTUAL-CONVENTION, is used to concisely convey the syntax and semantics of a textual convention.

RFC 2580, Conformance Statements for SMIv2, defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates a DMF and PF within a RAC framework of a development environment for network management applications that resolves the above-referenced difficulties and others.

### SUMMARY OF THE INVENTION

A method of developing one or more application programs that cooperate to manage a distributed system comprising one or more servers is provided. At least one application program is associated with each server. In one aspect, the method includes: a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system, b) parsing the one or more resource definition language files to ensure conformity with the object-oriented resource definition language and creating an intermediate representation of the distributed system from the one or more conforming resource definition language files, c) processing the intermediate representation of the distributed system to form one or more programming language classes, one or more database definition files, and one or more script files, d) providing a reusable asset center framework to facilitate development of the one or more application programs, the reusable asset center including a data management framework that provides creation, deletion, modification, and browsing functions in conjunction with the one or more managed objects and a database for storing data associated with the one or more managed objects, and e) building the one or more application programs from at least the one or more programming language classes, one or more database definition files, one or more script files, and the reusable asset framework.

A method of developing one or more application programs in operative communication to manage a network including one or more servers is provided. At least one application program is associated with each server. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network created in the parsing step includes a parse tree, c) processing the parse tree to form one or more programming language classes, wherein the one or more programming language classes formed include at least one of one or more system classes, one or more module classes, one or more managed object classes, and one or more composite attribute classes, d) providing a reusable asset center framework to facilitate development of the one or more application programs, the reusable asset center including a persistence framework that provides persistent data storage functions in conjunction with the one or more managed objects and a database for storing data associated with the one or more managed objects, and e) building the one or more application programs from at least the one or more programming language classes and the reusable asset framework.

A method of developing an application program to manage a network is provided. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network includes object meta-data, c) processing the object meta-data to form one or more programming language classes, one or more database definition files, and one or more script files, wherein the one or more programming language classes formed include at least one of an index class and a query class, d) providing a reusable asset center framework to facilitate development of the application program, the reusable asset center including a data management framework that provides creation, deletion, modification, and browsing functions in conjunction with the one or more managed objects and a database for storing data associated with the one or more managed objects and a persistence framework that cooperates with the data management framework to selectively provide persistent data in the database for the one or more managed objects, and e) building the application program from at least the one or more programming language classes, one or more database definition files, one or more script files, and the reusable asset framework.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a run-time network management environment showing aspects of a data management framework (DMF), a persistence framework (PF), and related frameworks within network management applications.

FIG. 10 is a block diagram of an embodiment of agent and data servers of a run-time network management environment showing aspects of the DMF, PF, and related frameworks within with network management applications.

FIG. 11 is a block diagram of an embodiment of the DMF.

FIG. 12 is a block diagram of an embodiment of data access classes of the DMF.

FIG. 13 is a block diagram of an embodiment of view management classes of the DMF.

FIG. 14 is a block diagram of an embodiment of managed object (MO) server view interface classes associated with the view management classes of the DMF.

FIG. 15 is a block diagram of an embodiment of view notifier classes associated with the view management classes of the DMF.

FIG. 16 is a block diagram of an embodiment of a data server of a run-time network management environment showing interaction between aspects of the DMF and PF within a server network management application and a database application.

FIG. 17 is a block diagram of an embodiment the PF.

FIG. 18 is a block diagram of an embodiment of a data server of a run-time network management environment showing interaction between a server network management application and a database application.

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1) creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be regenerated. Thus, streamlining change management of the network management application. The revised network management application is provided in a consistent and controlled manner through the object-oriented programming characteristics of MODL and the RAC management framework.

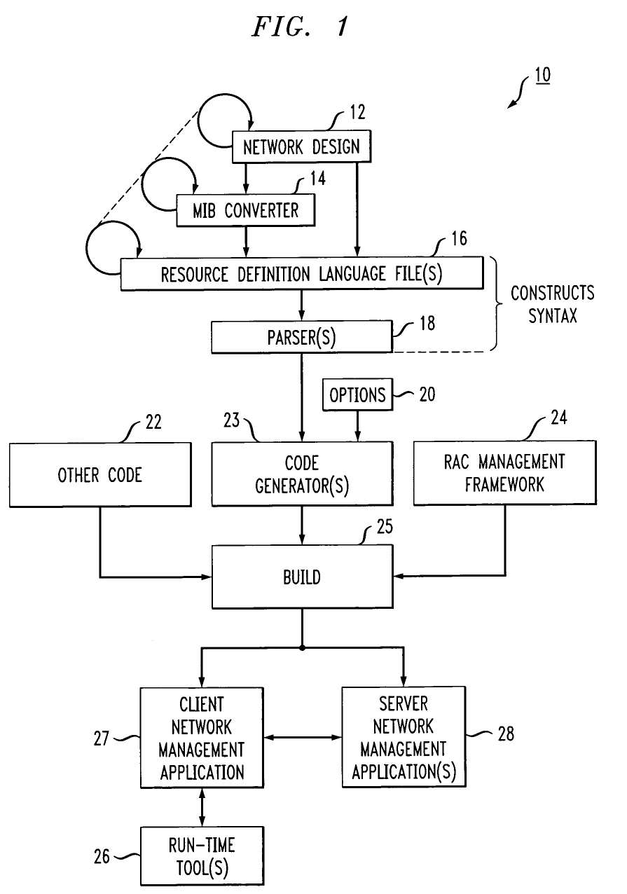

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

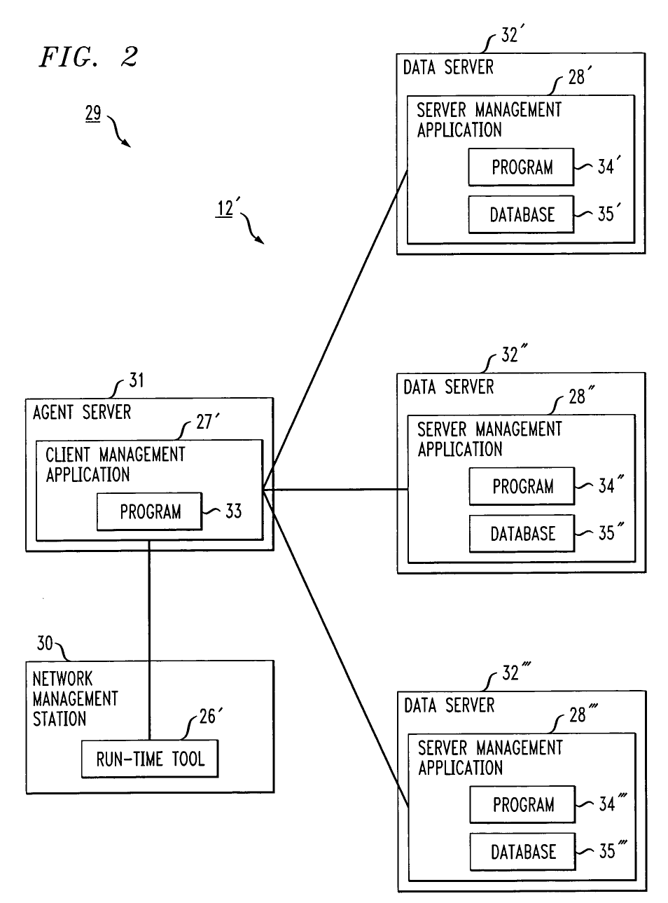

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32″, 32′″ each include a corresponding embodiment of the server network management application 28′, 28″, 28′″. The client network management application 27′ includes an application program 33. Each server network management application 28′, 28″, 28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

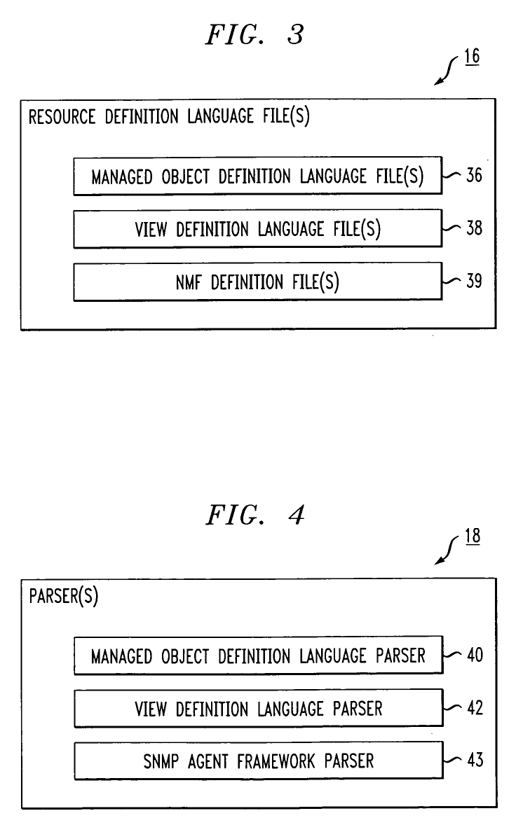

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

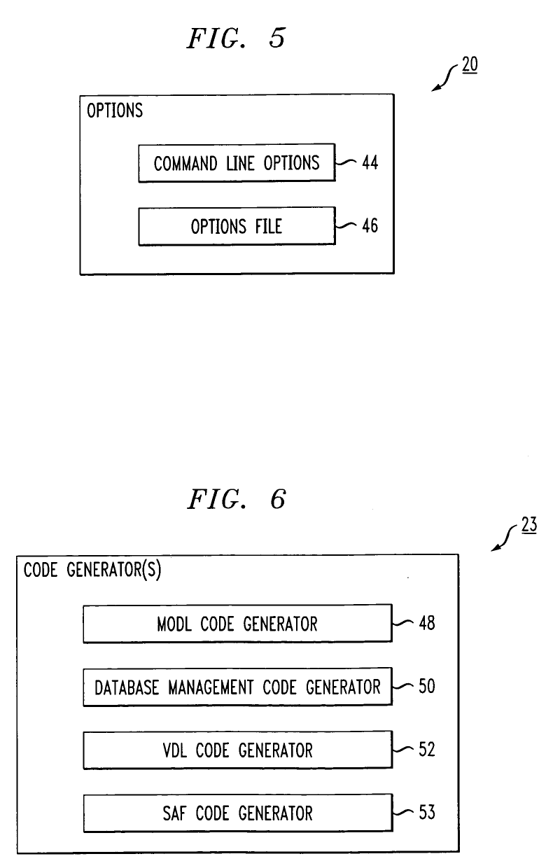

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

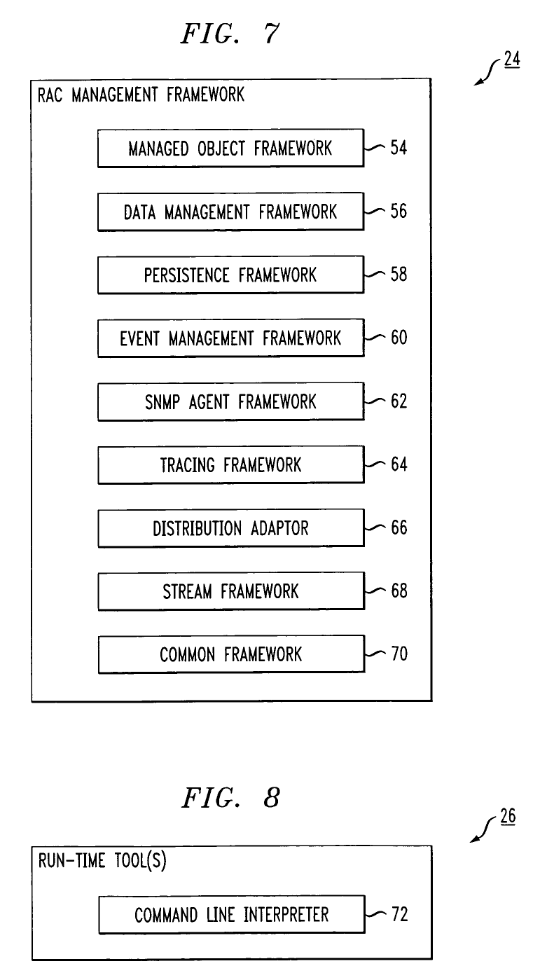

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

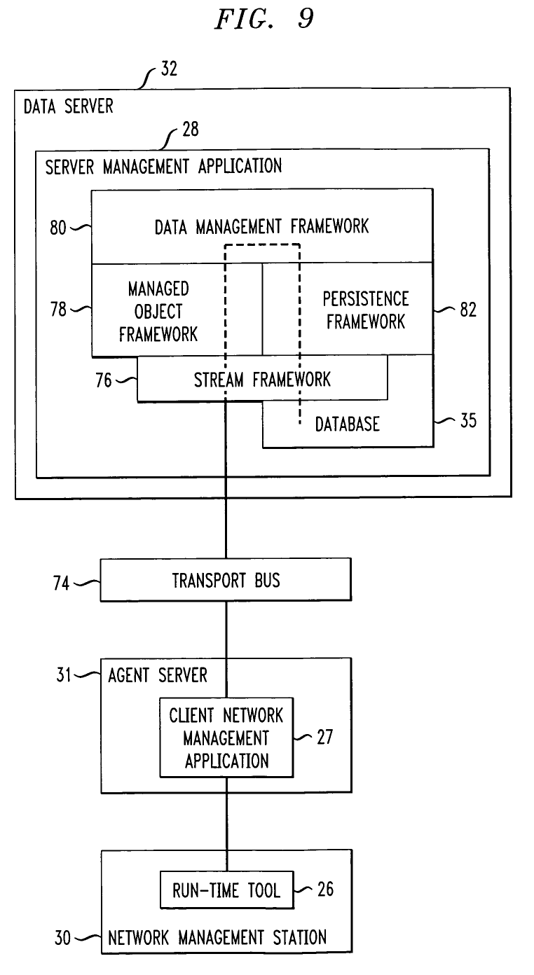

With reference to FIG. 9, an embodiment of a run-time network management environment includes the NMS 30, agent server 31, data server 32, and a transport bus 74. The NMS 30 includes the run-time tool 26. The agent server 31 includes the client network management application 27. The data server 32 includes the server network management application 28. The server network management application 28 includes the database 35, a stream framework component 76, an MOF component 78, a DMF component 80, and an optional PF component 82.

The run-time tool 28 is in communication with the client network management application 27. The client network management application 27 is in communication with the server network management application 28, for example, via the transport bus 74. Within the server network management application 28, the stream framework component 76 acts as an interface between the transport bus 74 and the MOF component 78 and between the PF component 82 and the database 35. As shown, communications from the client network management application 27 flow through the transport bus 74, stream framework component 76, MOF component 78, DMF component 80, PF component 82, and stream framework component 76 to the database 35. Communications from the database 35 to the client network management application 27 flow in reverse sequence through these components.

One objective of the DMF component 80 is to make managed objects persistent and to make these persistent managed objects accessible to the NMS 30. The DMF component 80 also allows various servers associated with the network management applications 27, 28 to share persistent data in real time, while maintaining consistency of the data.

The DMF component 80 provides a set of C++ classes that can be used by network management applications 27, 28 to support creation, deletion, modification, and browsing of persistent managed objects, persistent managed object loading, use of managed object views, data validation, and group data operations. Any type of managed object defined through the MOF component 78 can become persistent through the DMF component 80. The DMF component 80 supports loading any managed object from the database 35 based on its distinguished name.

A managed object view is a logical group of attributes associated with managed objects. The physical location of the attributes may be scattered over the database 35. Using managed object views, the network management applications 27, 28 can get needed data for multiple attributes through a single interface call, rather than accessing the scattered data through multiple interfaces. A network management application 27 or 28 can register for managed object view or view change notification. When an attribute that has been registered for change notification is changed, the DMF component 80 generates a notification and sends it to each application that is registered for the corresponding change notification. The managed object view can be created before the creation of any object instance that is included in the view. View data can be loaded and synchronized with the managed object data in database at any time. The DMF component 80 keeps a reference count for view instances so that only one instance of a view is created in a process. The DMF component 80 enforces data validation rules and data access rules on behalf of the network management applications before managed object data is changed in the database. The DMF component 80 supports group data access in a single transaction manner within a single application program interface (API) call.

The DMF component 80 is the glue between the PF component 82 and the MOF component 78. The DMF component 80 uses the PF component 82 to persist managed objects in the database 35. On the other hand, the DMF component 80 uses the MOF component 78 to receive commands from the NMS 30 through the agent server 31 to manipulate the managed object on the database 35. The DMF component 80 also uses the MOF component 78 to forward notifications about changes that are made in the database 35.

The block diagram illustrates the relationship between the DMF component 80 and other RAC frameworks related to data access. The DMF component 80 receives MOF requests from a managed object client and translates those requests into the appropriate API calls to the PF component 82 to access the database 35.

In one characterization of the DMF 56 (FIG. 7), it can be described in terms of five major components: 1) a persistence attribute server class, 2) managed object handle classes, 3) managed object adaptors, 4) a managed object view subsystem, and 5) a view notification class. The persistence attribute server class specializes the general attribute server interface to provide APIs for accessing persistent managed objects. The managed object handle classes are for data accessing. The managed object adaptors chain data access requests to corresponding persistent object handles or forward data change notifications. The managed object view subsystem provides access to a group of attributes of persistent managed objects. The view notification class keeps view data in sync with the database.

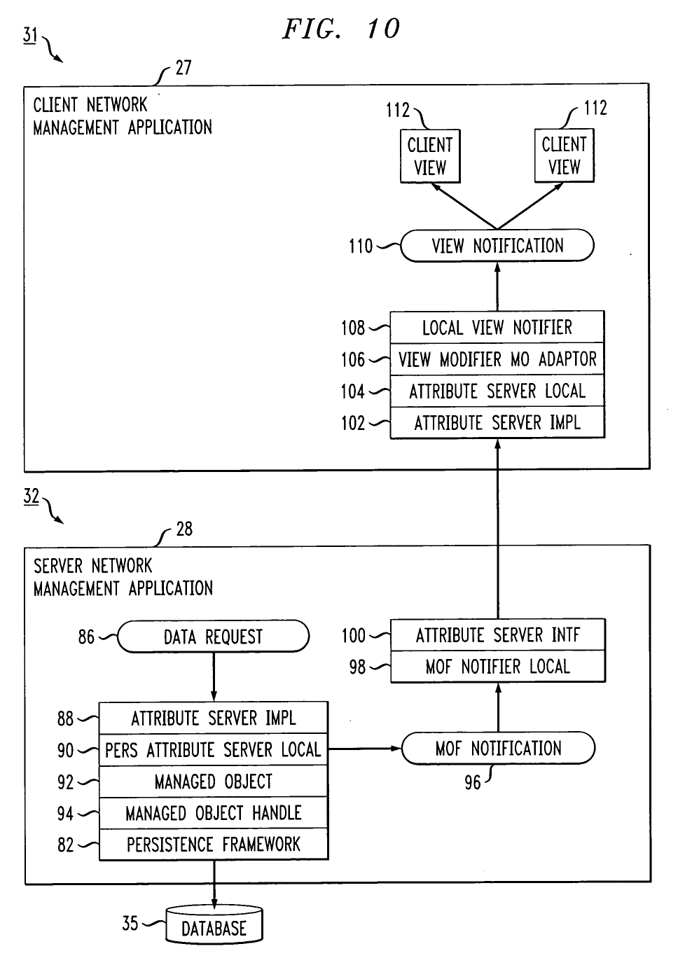

With reference to FIG. 10, an embodiment of the agent server 31 and the data server 32 of a run-time network management environment is provided. The agent server 31 includes the client network management application 27. The data server 32 includes the server network management application 32 and the database 35.

The server network management application 28 includes the optional PF component 82, a data request action 86, an attribute server implementation component 88, a persistence attribute server local component 90, a managed object component 92, a managed object handle component 94, an MOF notification action 96, an MOF notifier local component 98, and an attribute server interface component 100.

The client network management application 27 includes an attribute server implementation component 102, an attribute server local component 104, a view modifier managed object adaptor component 106, a local view notifier component 108, a view notification action 110, and multiple client view components 112.

The block diagram shows the main function flow between the MOF and DMF components for data access request and notification. The process is initiated when the data request action 86 is communicated to the attribute server implementation component 88. The attribute server implementation component 88 provides request information to the persistence attribute server local component 90. The persistence attribute server local component 90 initiates the MOF notification action 96, which is communicated to the MOF notifier local component 98. The MOF notifier local component 98 provides notification information to the client network management application 27 via the attribute server interface component 100. The request information is provided to the database 35 through persistence attribute server local component 90, managed object component 92, managed object handle component 94, and the PF 82.

The attribute server implementation component 102 receives the notification information and communicates it through the attribute server local component 104 and view modifier managed object adaptor component 106 to the local view notifier component 108. The local view notifier component 108 initiates the view notification action 110 which updates the client views 112.

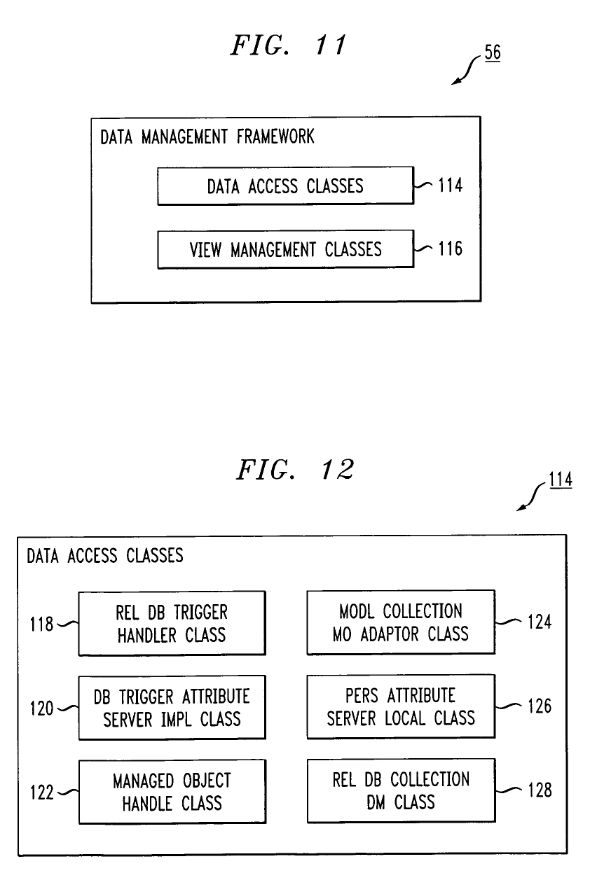

With reference to FIG. 11, the DMF 56 includes data access classes 114 and view management classes 116. The data access classes 114 support access to managed object data in the database. The view management classes 116 support operations associated with customized views of managed object data.

With reference to FIG. 12, the data access classes 114 include a relational database trigger handler class 118, a database trigger attribute server implementation class 120, a managed object handle class 122, an MODL collection managed object adaptor class 124, a persistence attribute server local class 126, and a relational database collection data management class 128.

The relational database trigger handler class 118 serves the purpose of passing database change information on the database side through a communication channel to the data server side when a user changes data directly on database. This class is typically used in conjunction with the database trigger attribute server implementation class 120 on the data server side to handle certain events that occur in the database. For example, create tuple, delete tuple, and update tuple events. The relational database trigger handler class 118 translates a tuple in the relational database to a managed object. The relational database trigger handler class 118 invokes a corresponding API of the database trigger attribute server implementation class 120 based on the type of database event.

The database trigger attribute server implementation class 120 invokes application trigger function for any data change in the database if trigger is installed. This class specializes the attribute server interface to provide a generic way to handle data base trigger at the data server side. The database trigger attribute server implementation class 120 is typically used in conjunction with the relational database trigger handler class 118 at database side. The database trigger attribute server implementation class 120 enforces data consistency checking for any change that is made directly in the database without using RAC APIs (e.g., changes through standard query language (SQL), JDBC, etc). The database trigger attribute server implementation class 120 sends notification to interested network management applications when data changes occur through direct database operations.

The managed object handle class 122 abstracts database operations for managed objects. This class makes the underlying database implementation transparent to the network management application. For each type of managed object class, there is a corresponding managed object handle class 122 that retrieves data from the database for an instance of managed objects of that type. The managed object handle class 122 supports: 1) creation, deletion, and updates for managed objects in the database, 2) loads a managed object from the database, and 3) finds a managed object in the database.

The MODL collection managed object adaptor class 124 is a base class for all RAC-generated adaptor classes of persistent managed objects. This class can create, delete, and update managed object in the database through the DMF 56 and, when database persistence is implemented, the PF 58. The MODL collection managed object adaptor class 124 supports APIs in a process that is local to the database that are able to create a managed object, delete a managed object, update an attribute associated with a managed object, and retrieve an attribute for a managed object. For persistent classes, a subclass of the MODL collection managed object adaptor class 124 is generated by the MODL code generator 48 (FIG. 6). The network management application may call a procedure (e.g., PersdaptorsDefn::initializePersistentMoAdaptors( )) to install these adaptors for persistent classes in the data server process.

The persistent attribute server local class 126 specializes the attribute server local class for persistent purposes. This class is used by the server network management application 28 that is local to the database to provide data server functionalities for persistent data. For example, the data server functionalities include browsing persistent managed objects, manipulating (i.e., creating, deleting, or updating) persistent managed objects, providing transaction semantics for group operations, dispatching actions associated with persistent managed objects, and using the MOF notification service to send notifications of changed to the data to interested network management applications.

The relational database collection data management class 128 has the knowledge managed objects instances from the database. This class is typically used in the server network management application 28 that is local to the database. The relational database collection data management class 128 supports loading managed object instances by corresponding given class names and loading a managed object by its given distinguished name.

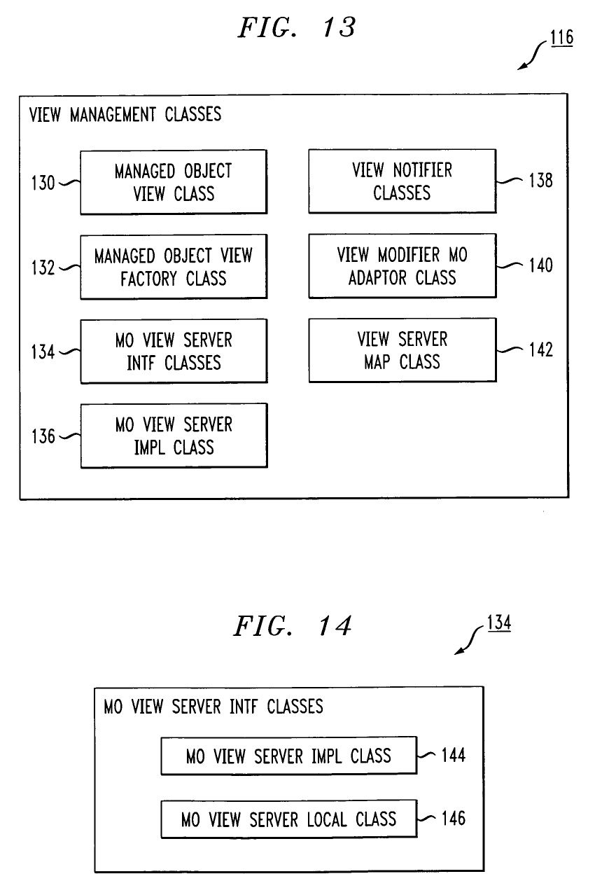

With reference to FIG. 13, the view management classes 116 include a managed object view class 130, a managed object view factory class 132, managed object view server interface classes 134, a managed object view server implementation class 136, view notifier classes 138, a view modifier managed object adaptor class 140, and a view server map class 142.

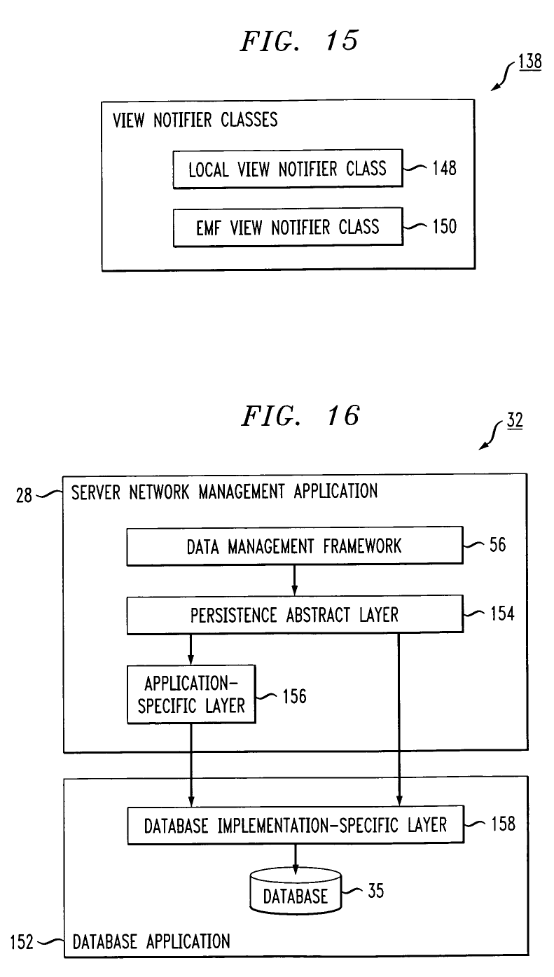

The managed object view class 130 is an abstract class. This class allows the network management application to access multiple managed object attributes through a single interface. For each defined view, the RAC development environment generates a subclass of this class to support data specific operations for the view. For example, updating the view when the database is changed. The managed object view class 130 provides APIs for opening, closing, and updating a view, locking a view, reading data associated with a view, and syncing view data with the database. A new instance of the managed object view class 130 automatically registers itself with a managed object view server local class 146 (FIG. 14) to allow view sharing in a process.

The managed object view factory class 132 is a common base class for specific view factory classes generated by the VDL code generator 52 (FIG. 6). The managed object view factory class 132 provides a common way to create a view by given view indexes (also called view instance ID). This class also provide static APIs for getting a specific view factory by providing the view class name and adding a specific view factory in a managed object view factory list that is used by the RAC framework to find a view factory by given a view class name.

The managed object view server interface classes 134 are generic interface classes that define APIs for view management. For example, view management APIs may include APIs to open a view or list of views, close a view or list of views, or get view data. The managed object view server interface classes 134 provide concurrent control access to shared views in a process.

The managed object view server implementation class 136 is the actual CORBA implementation class for an IDL interface to a view server. The main responsibility of this class is to get view data from the database. The managed object view server implementation class 136 may be used to replace *Id1Imp1 classes for developer-defined views generated by the RAC development environment. For example, the RAC development environment will generate an IDL interface for each view definition. However, instead, the generic view server and managed object view server implementation class 136 may be used to serve the needs for CORBA views.

The view notifier classes 138 are generic classes that provide APIs for sending data change notifications to the views. The view notifier classes 138 find view definitions by a given managed object distinguished name and changed attributes. Subclasses of the view notifier classes 138 send notifications to the affected views in the process or to the interested server.

The view modifier managed object adaptor class 140 is subclass of the managed object adaptors. This class receives an MOF notification when a registered managed object is changed in the database and passes the notification to the local views in the process by invoking view notifier APIs. The MOF notifications have the same format as MOF operation commands associated with creating a managed object, deleting a managed object, updating an attribute for a managed object, and retrieving an attribute for a managed object.

The view server map class 142 provides a common interface for network management applications to define ways to find the view server object by a given object name. A subclass of this class provides the function ViewServerMap::getViewServerObjRef( ). The DMF 56 uses this function to find the view server object for retrieving view data from the database.

With reference to FIG. 14, the managed object server view interface classes 134 include a managed object view server implementation class 144 and a managed object view server local class 146. The managed object view server implementation class 144 provides static API to get view data through CORBA calls for remote CORBA reviews (i.e., generated view classes by the VDL code generator 52 (FIG. 6)). This class is mainly used by the DMF 56. The managed object view server local class 146 is responsible for managing all view instances on the given local process. This class also provides the capability of view sharing, including opening a view or list of views, closing a view or list of views, and registering a newly created view for sharing.

With reference to FIG. 15, the view notifier classes 138 include a local view notifier class 148 and an EMF view notifier class 150. The local view notifier class 148 is used by the DMF 56 to send data change notifications to affected views managed by the process. This class notifies the views by invoke APIs, such as moCreated, moDeleted, and updateAttributes on those views. The EMF view notifier class 150 notifies an event server object associated with the EMF 60 (FIG. 7) about view data changes.

The following paragraphs provide an example of steps that a developer may use for building a data server 32 (FIG. 10) using the DMF 56 (FIG. 11). The exemplary data server 32 (FIG. 10) can accept requests for data accessing and send notifications for data change. Initially, the developer loads the managed object definitions for all managed objects that are to be monitored by the data server 32 (FIG. 10). View factories are registered for all views that the data server needs to serve. Persistence service is initialized by calling the method PersInitializer::init( ) of the MODL code generator 48 (FIG. 6). The persistence attribute server local component 90 (FIG. 10) is used as a server object for data access. The MOF notifier local component 98 (FIG. 10) is used as a server object for sending out MOF notifications 96 (FIG. 10). An instance of the managed object view server implementation class 136 (FIG. 13) is created for a server object to get view data for clients. These server objects are registered with a CORBA portable object adaptor (POA). The following highlights exemplary data server related code.

```
  DataServerMain.C
...
#include “mof/AttributeServerImpl.h”
#include “mof/MofNotifierImpl.h”
#include “dmf/PersAttributeServerLocal.h”
#include “dmf/MoViewServerImpl.h”
//include generated headers
#include “PersInitializer.h”
#include “AttrDefns.h”
#include “MoDefns.h”
#include “ViewDefs.h”
#include “CellSiteDBView.h”
...
int main(...)
{
  //set the data server identifier
  ServerId serverNameId(“DataServer”,1);
  ServerId::thisServerId(serverNameId);
  //Register your Modefns and AttrDefns
  AttrDefns::registerAttributeFactories( );
  MoDefns::createManagedObjectDefs( );
  // Initialize persistence service by calling ModlGen
generated method
  PersInitializer::init( );
  //Register this process to use the DBView
  CellSiteDBView::useThisView( );
  ViewDefs::create( );
  RUBY_TRY {
    CORBA::ORB_var orb = CORBA::ORB_init(argc, argv);
    //Create an instance of
AttributeServerInterfaceImpl for AttributeServer IDL
    //to serve data access requests through CORBA bus.
    //Set PersAttributeServerLocal as the
implementation of AttributeServerInterface
    //that is used by AttributeServerInterfaceImpl
    POA_AttributeServer_tie<AttributeServerImpl>*
asiServant =
      RUBY_CORBA_NEW POA_AttributeServer_tie
<AttributeServerImpl>(
        new AttributeServerImpl(
          new PersAttributeServerLocal(1)));
    //Set a server object with MofNotifier interface so
that the data server
    //can use it to send MOF notifications for clients
    POA_MofNotifier_tie<MofNotifierImpl>*
notifierServant =
      RUBY_CORBA_NEW POA_MofNotifier_tie
<MofNotifierImpl>(
        new MofNotifierImpl
(MofNotifierLocal::instance( ));
    //Instantiate the view server object so that the
Data Server clients
    //can access view data
    POA_ViewServer_tie<MoViewServerImpl>* viewservant =
      RUBY_CORBA_NEW POA_ViewServer_tie
<MoViewServerImpl>(
        new MoViewServerImpl );
    //register your servants with your POA(s)
    //register your objectrefs so they can be retrieved
by your client
    //enter your CORBA loop
    orb->run( );
  }
  RUBY_CATCH(CORBA::SystemException, se) {
    RUBY_PRINT_SYSTEM_EXCEPTION(se);
  }
  RUBY_CATCHANY{
    cerr << “main: Unrecognised exception in main loop”
<< endl;
  }
}
```

The following paragraphs provide an example of steps that a developer may use for building a data server client (i.e., agent server 31 (FIG. 10)) using the DMF 56 (FIG. 11). The data server client is a process that accesses data related to managed objects and/or a process that maintains managed object views instances. Initially, the developer installs an instance of the attribute server implementation component 102 (FIG. 10) in the data server client so the client process can receive MOF notifications from the CORBA transport bus. The following code provides an example of an attribute server implementation component 102 (FIG. 10).

```
ServerId serverNameId (“myClient”, 1);
RUBY_SERVANT_TYPE(AttributeServer,AttributeServerImpl)*
server =
  RUBY_CREATE_CORBA_OBJ_REF(AttributeServer,
AttributeServerImpl);
// one way to register it with POA
if( RubyPoaSpecific::registerObjRefWithPoa(server,
serverNameId,
        “AttributeServer” ) == NULL ) {
return −1;
}
```

The developer sets up the handle for the data server client with the data server 32 (FIG. 10) so the client process can send MOF operation requests to the data server 32 (FIG. 10). The following code provides an example of setting up a handle for the data server client with the data server 32 (FIG. 10).

AttributeServerInterface *dsHandle =
ProxyFinder<AttributeServerInterface>::GetProxy(
“DataServer”, “DataServer”, 0 );
// using data server for data accessing
dsHandle -> setAttributes (dn, myAttrList);

The developer sets up the handle for the data server client with the MOF notification server object. This permits the client process to register for notifications from the data server 32 (FIG. 10) in conjunction with the managed objects in which the data server client is interested. The following code provides an example of setting up a handle for the data server client with the MOF notification server object.

MofNotifierInterface* dsNotifier =
ProxyFinder<MofNotifierInterface>::GetProxy(
“DataServer”, “DataServer”, 0 );

The developer registers MOF notifications 96 (FIG. 10) for all managed objects for which the data server client is interested. For example, the following code provides an example of registering MOF notifications (FIG. 10) for managed object class MoA in module MyTest.

dsNotifer->registerForClass(
MyTestAttrDefns::MoA::getFullClassName( ),
serverNameId, MofNotifierInterface::Push,
MofNotifierInterface::MofAll);

If the client process contains any view that monitors managed objects, for example, a view named CellSite that contains managed object instances of Cell and Radio, the developer performs the following steps in order to keep view data in sync with the database 35 (FIG. 10). The developer instantiates an instance of the local view notifier class 148 (FIG. 15) for sending out view notifications 110 (FIG. 10) for views opened locally after the client process received an associated MOF notification 96 (FIG. 10). The developer also instantiates an instance of the view modifier managed object adaptor class 140 (FIG. 13) for each managed object class that has been declared in a view. The view modifier managed object adaptor APIs are invoked when an MOF notification 96 (FIG. 10) is received. The view modifier managed object adaptor class 140 (FIG. 13) invokes view notifier classes 138 (FIG. 13) to send view notifications 110 (FIG. 10). The developer registers for MOF notifications 96 (FIG. 10) for each managed object used by a view as mentioned above. The developer also registers the view factory for each view class used in the views. The view factory is invoked by the RAC management framework 24 (FIG. 7) when a new view is created. This provides view callback functions and installs them when needed. The code generated by the RAC development environment 10 (FIG. 1) invokes view callback functions (if installed) on behalf of network management applications. This can be accomplished by either inserting the code into the RAC generated code for XXXViewCallback.C or by using subclass XXXViewCallback to provide callback functions. For example, the following code provides callback functions for managed object deletion and creation for view CellSite.

```
//define the callback functions:
class TestViewCallback : public CellSiteCallback {
    int viewMoCreated( MyView *view,
      const DistinguishedName& dn,
      const AttributeList& attrList);
  int viewMoDelete(MyView *view, const
DistinguishedName& dn)
  {  your action of post-deletion here ... }
  }
```

The developer installs the callback function for the view in the client process containing the view using the following exemplary code.

TestViewCallback* callback = new TestViewCallback( );
CellSiteView::setViewCallback( callback );

The developer may use the view server map class 142 (FIG. 13) to define how the view server object gets view data from the database 35 (FIG. 10). For example, if the data server process contains the view server object, as mentioned above, one way to define the server map is by using the following exemplary code.

```
Class CellSiteViewServerMap : public ViewServerMap {
  Public:
    CellSiteViewServerMap(void) { };
// define how to get the view server object reference
getViewServerObjRef( const char* viewName ) {
        ServerId dsId(“DataServer”,0);
        return RubyCorbaHelper::getIor( dsId,
“ViewServer” );
};
          }
```

Then, the client process installs the map. The following exemplary code demonstrates how the map sets up the client process containing the desired views. In this example, the client process uses a CORBA view named CellSite that contains managed objects Cell and Radio in a module called DemoSystem.

```
HWServerMain.C
...
#include “mof/AttributeServerImpl.h”
#include “mof/MofNotifierImpl.h”
#include “dmf/PersAttributeServerLocal.h”
#include “dmf/MoViewServerImpl.h”
//include generated headers
#include “AttrDefns.h”
#include “ViewDefs.h”
#include “CellSiteCorbaView.h”
...
//If the client process contains Managed Object Views
make sure you have implemented
//your own ServerMap and ViewServerMap
#include “YourServerMap.h”
#include “YourViewServerMap.h”
int main(int argc,char** argv)
{
  //Assume our instanceId is the first argument
  int instanceId = atoi(argv[1]);
  ServerId serverNameId(“HWServer”,instanceId );
  ServerId::thisServerId(serverNameId);
  //Set your ServerMaps
  ServerMap::instance(new YourServerMap );
  ViewServerMap::instance(new YourServerMap );
  //Register attribute definitions information
  AttrDefns::registerAttributeFactories( );
  //Register this process to use the CorbaView
  CellSiteCorbaView::useThisView( );
  //Register your View Definitions
  ViewDefs::create( );
  //Create the ViewModifierAdaptors to receive the MOF
Notification
  //and pass it to the ViewNotifier
  ViewModifierMoAdaptor viewMoAdaptor1(
    DemoSystemAttrDefns::Cell::getFullClassName( ));
  ViewModifierMoAdaptor viewMoAdaptor2(
    DemoSystemAttrDefns::Radio::getFullClassName( ));
  //Install view notifier for views managed by this
process
  //LocalViewNotifer will send out view notifications to
affected views based on
  //MOF notifications information
  ViewNotifier::instance( new LocalViewNotifier( ) );
  RUBY_TRY {
    CORBA::ORB_var orb = CORBA::ORB_init(argc, argv);
    //Initialize an instance of AttributeServerImpl for
the client process to
//receive MOF notifications coming from CORBA
communication bus
    POA_AttributeServer_tie<AttributeServerImpl>*
asiServant =
      RUBY_CORBA_NEW
POA_AttributeServer_tie<AttributeServerImpl>(
        new AttributeServerImpl(
          new AttributeServerLocal));
//Get the handle to the MOF Notification server object so
that the client
//process can register notification for the managed
objects it is interested
    MofNotifierInterface* notifier =
      ProxyFinder<MofNotifierInterface>::GetProxy(
        “DataServer”, “DataServer”, 0 );
    //Register to receive MOF notifications only for the
Cell
    //were watching and all objects underneath that Cell
    //if watching more than 1 cell change registration
    //to a registerForClass instead of
registerForObjectTree
    DistinguishedName cellDn;
    DemoSystemCellMO::getDefaultDn(cellDn);
    cellDn.setValue(1,instanceId);
    notifier->registerForObjectTree(cellDn,serverNameId,
      MofNotifierInterface::Push,
      MofNotifierInterface::MofAll);
    // Do the similar thing for the Radio managed object
//register the servants object reference with POA(s) here
    / so that they can be retrieved by this process
clients
    //enter your CORBA loop
    orb->run( );
  }
  RUBY_CATCH(CORBA::SystemException, se) {
    RUBY_PRINT_SYSTEM_EXCEPTION(se);
  }
  RUBY_CATCHANY{
    cerr << “main: Unrecognised exception in main loop”
<< endl;
  }
}
```

The DMF 56 (FIG. 11) keeps a list of opened views in a process and tracks the reference count for those created views so the views can be safely shared by multiple threads in a process. A view can be opened/created by calling the static method ManagedObjectView::openView( ) with the option of populating the view data at open time or at a later time. After a user is done with a view, ManagedObjectView::closeView( ) should be called so the view reference count gets deducted. When a view reference count returns to zeros, the DMF 56 (FIG. 11) removes the view from the global sharing list and the view is deleted.

The DMF 56 (FIG. 11) provides multiple ways for a network management application to perform data constraints checking. For example, a developer can define a data range of an attribute in the MODL file 36 (FIG. 3). This causes the MODL code generator 48 (FIG. 6) to generate code in the function checkAttributes( ) of a ManageredManagedObject subclass corresponding to the defined data range. The developer can also overwrite the checkAttributes( ) function to add more data checking code besides that which is generated by the MODL code generator 48 (FIG. 6). Additionally, the developer can use “ModlGen -d” option when running the MODL code generator 48 (FIG. 6) to generate the ADS DDE file so more constraints can be added besides those supported by the MODL code generator 48 (FIG. 6). To have data constraints checking for data changes that do not operate through APIs calls, the developer may use the database trigger and the trigger handle mechanism provided by the RAC development environment.

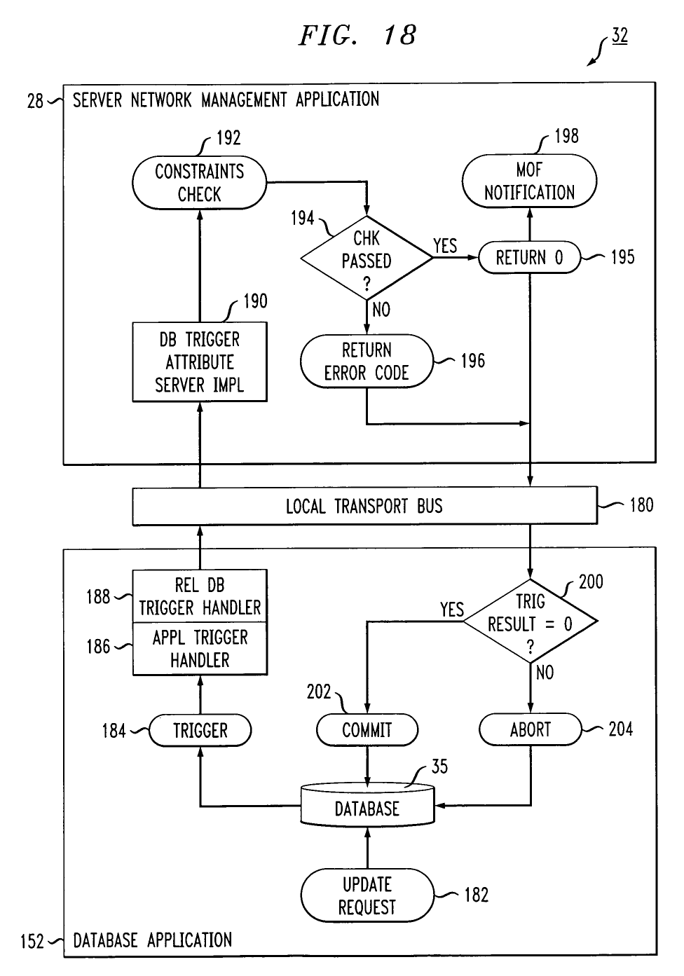

When persistence of the managed objects in the database 35 (FIG. 9) is desired, the PF 58 (FIG. 7) is implemented in the RAC framework 24 (FIG. 7) and used to build the network management applications 27, 28 (FIG. 9). With reference to FIG. 17, the PF 58 is used to make the network management applications transparent of any underlying database implementation. The PF 58 is optional and designed to add management object persistence to the management features of the DMF 56 (FIG. 11). Typically, the network management applications do not use the PF 58 directly, using it indirectly through the DMF 56 (FIG. 11).

The PF 58 includes a set of C++ classes used by the DMF 56 (FIG. 11) to support: 1) persistence storage for managed objects, 2) portability across databases, 3) database transactions, 4) database trigger handling, 5) multi-schema, and 6) uniform error handling. The PF 58 can be used with a third party database (e.g., DataBlitz, commercial database application developed by Lucent Technologies and currently outsourced to Mascon Technologies) to provide persistence services for managed objects. The PF 58 also provides a uniform interface for the backend of the database 35 (FIG. 10). Switching database implementations should have no impact or very limited impact on code associated with the RAC development environment 10 (FIG. 1), including code associated with the DMF 56 (FIG. 11) and the PF 58.

The PF 58 provides general database transaction APIs and macros that are independent of the database implementation. The PF 58 also provides database trigger handling classes that can be used to insure the data integrity checking is invoked when data is changed in the database and to notify database clients about the changes. The PF 58 provides APIs to access a named schema in the database. This gives the network management application the ability to share the database with other database applications by using different (i.e., multiple) schemas in the database.

The PF 58 provides uniform error handling that is consistent across different backends to the database 35 (FIG. 10). For example, the library associated with the PF 58 defines a set of standard exceptions that are common to various database implementations.

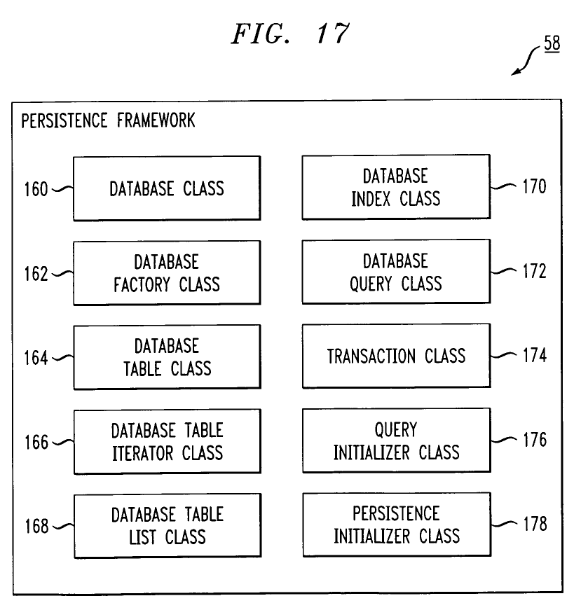

With reference to FIG. 16, the PF 58 on the data server 32 provides a portable persistent interface to the database 35 for the server network management application 28 through a layered architecture. The layered PF architecture includes the DMF 56, a persistence abstract layer 154, application-specific layer 156, and a database implementation-specific layer 158.

The persistence abstract layer 154 provides an interface for database access. The interface is uniform for the any database backend. The persistence abstract layer 154 hides the database specification from client network management applications 27 (FIG. 9) by communicating with the database implementation-specific layer 158 to access data. The primary classes in the persistence abstract layer 154 include: 1) a database class, 2) a database factory class, 3) a database table class, 4) a database table iterator class, 5) a database table list class, 6) a database index class, 7) a database query class, 8) a transaction class, 9) a mapping class between database objects and managed object instances, 10) a pointer to object identification (POID) class, 1) POID factory class, and 12) POID factory finder class. The POID, POID factory, and POID factory finder classes are usually deprecated.

The database implementation-specific layer 158 is implementation-specific with respect to the database backend. This layer implements the functionalities provided by the persistence abstract layer 154. The database implementation-specific layer 158 is affected when the database 35 is changed. For example, when the DataBlitz relational database is use, the database implementation-specific layer includes the following classes: 1) a Blitz relational database table class, 2) a Blitz relational database table iterator class, 3) a Blitz relational server database class, 4) a Blitz relational database factory class, 5) a Blitz transaction implementation class, 6) a Blitz relational POID class, 7) a Blitz relational POID factory class, and 8) a database table persistence array implementation class.

The application-specific layer 156 includes a set of C++ classes generated by the database management code generator 50 (FIG. 6). The application-specific layer 156 is dependent on the database implementation. The generated classes are specialized to define the database indices and queries based on the managed object definitions in a *.odl file for the server network management application 28. The application-specific layer 156 also contains classes that interpret the data buffer from the database for the responding managed object instances. The classes in this layer include: 1) a <Mo name> database query class, 2) a <Mo name> database index class, 3) a <Mo name> managed object handle class, 4) a query initializer class, and 5) a persistence initializer class.

With reference to FIG. 17, the primary classes of the PF 58 that are used by other RAC frameworks and network management applications include a database class 160, a database factory class 162, a database table class 164, a database table iterator class 166, a database table list class 168, a database index class 170, a database query class 172, a transaction class 174, a query initializer class 176, and a persistence initializer class 178. To minimize the dependency of network management applications on the backend database implementation and to minimize changes to the PF 58, network management applications typically use specialized factory classes to install the concrete classes and generic APIs defined in the persistence abstract layer 154 (FIG. 16) to access the database 35 (FIG. 16).

The database class 160 defines general database operations, for example, open/close database, set access mode (e.g., read only, read write, write only), set data storage type (e.g., persistent, transient), and set/get database factory operations.

The database factory class 162 provides an interface to create a database object. This class also provides configuration information about the associated database. The configuration information provided may include the type of database, for example, a create database, a create database table, a create database table iterator, and an IS relational database. Use of the specialized class Blitz relational database factory of the database factory class 162 to create database objects associated with the network management applications does not require code with DataBlitz-specific classes and APIs.

The database table class 164 represents a set of data in the database with the same data buffer definition. This class provides generic APIs to manipulate data in the data set (table), such as add/remove data, get data, modify data, and get data buffer size.

The database table iterator class 166 supports database table scan operations, such as open/close table scan, get a current data item in the table according to the curser, get a next data item in the table, and get a table object.

The database table list class 168 provides a thread-static list for database tables and provides APIs to access tables in the list, such as get a table based on name and populate a query on a table.

The database index class 170 captures the information that can be used to identify a data record in a database. Subclasses of the database index class 170 generated by database management code generator 50 (FIG. 6) based on managed object definitions contain managed object specific identifier information. The database index class 170 also supports the following functions: 1) copy from a given index, 2) duplicate the associated index, and 3) get/set the memory start location of an index.

The database query class 172 defines the generic APIs to manipulate database query. This class maintains a query list during the run time for query reuse. Subclasses of the database query class 172 generated by the database management code generator 50 (FIG. 6) based on managed object definitions contain managed object specific query information. The database query class 172 also supports the following functions: 1) populate a query for a database table, and 2) add/remove a query to/from a query list.

The transaction class 174 provides generic APIs and macros to support database transactions, such as begin transaction, commit transaction, and abort transaction. The database implementation-specific transaction is created by the transaction factory that is installed by a specific subclass of the database factory class 162, such as the Blitz relation database factory subclass.

The query initializer class 176 is generated by the database management code generator 50 (FIG. 6). This class is used to initialize database queries for all managed objects defined in the application *.odl file.

The persistence initializer class 178 is generated by the MODL code generator 48 (FIG. 6) and defines APIs to simplify application program steps for developers setting up the data server 32 (FIG. 16) for persistence services. The persistence initializer class 178 supports: 1) initialization of persistence services, 2) open database for a schema, and 3) load all managed objects from a schema

By default, DataBlitz creates the default schema “datablitz” in the database 35 (FIG. 16) for database applications 152 (FIG. 16). The server network management application 28 (FIG. 16) can isolate its own data from data associated with other applications that coexists in the database 35 (FIG. 16). This is done by naming its own schema for the managed object data associated with the server network management application 28 in the database 35 (FIG. 16). With a named schema, the server network management applications 28 can archive/restore the schema without interrupting other applications. To create a named schema in the database 35 (FIG. 16), the server network management application specifies the schema name and database identification in the *.opt file in the form shown below:

schema <schema name> <database id>

where the schema name is a string with a length in the 32 character range and the database id is an integer, typically larger than 10. The schema name and database id are unique across the database 35 (FIG. 16).

If triggers are used for the schema, the trigger libraries are typically named as shown below:

lib<schema name>[index].so

where the index is optional and may be a number, for example between two and five, inclusive.

Either using the default schema or a named schema scripts dbInstall.sh and runRe1ddl.sh generated by the database management code generator 50 (FIG. 6) can be used to create the schema in the database 35 (FIG. 16). For example, DbGen/dbInstall.sh will create the schema, tables, and indices in the database 35 (FIG. 16) that are defined in DbGen.ddl. Similarly, DbGen/dbInstall.sh -t will create the schema, tables, and indices in the database 35 (FIG. 16) that are defined in DbGen.ddl, as well as triggers that are defined in Trigger.ddl. Alternatively, DbGen/runRe1ddl.sh <you re1ddl files> will run re1ddl commands listed in the given files for the schema defined in the *.opt file associated with the server network management application 28 (FIG. 16).

Setting up persistence services for a data server 32 (FIG. 16) using the RAC framework 24 (FIG. 7) includes following steps: 1) set up the database, 2) bring up the database and create a schema in the database, 3) set up programming to initialize the data server, and 4) bring up the data server. These steps are explained in more detail in conjunction with exemplary procedures provided below.

Setting up the database environment for DataBlitz, for example, includes setting environment variables BLZ_ROOT and BLZ_DBPATH before bring up the database 35 (FIG. 16). The BLZ_ROOT variable points to where the database application 152 (FIG. 16) is located. The BLZ_DBPATH variable points to the physical location of the database application 152 (FIG. 16). For example, the following code may be used to set up these environment variables:

BLZ_ROOT = /bld/flexplat/SOURCES/LUSE/DBZ/DBZ_V5.0.Sg-
32CIO
BLZ_DBPATH= /tmp/Database.1.<userid>

DataBlitz uses a file sys.rc to configure the parameters used by DataBlitz processes. The search order of this file is: 1) $BLZ_DBPATH and 2) $BLZ_ROOT/lib. Typically, the developer copies the default syr.rc provided by DataBlitz from $BLZ_ROOT/lib to $BLZ_DBPATH and modifies the default parameters to fit the needs of the corresponding server network management application 28 (FIG. 16).

With reference to FIG. 18, an embodiment of a data server 32 that is set up for using a database trigger includes the server network management application 28, database application 152, and a local transport bus 180. The database trigger is fired by the database application 152 whenever data is changed in the database 35 and before the database 35 commits the change. The database trigger can be used for data constraints checking and data change notification. The PF 58 (FIG. 17) and database application 152 provide developers with the basic means to define and handle database triggers.

FIG. 18 shows how an update request 182 to the database 35 to change data through direct data access can be handled by the database application 152 and the server network management application 28 of a data server 32. The database application 152 includes the database 35, update request 182, a trigger 184, an application trigger handler 186, and a relational database trigger handler 188. The server network management application 28 includes a database trigger attribute server implementation 190, a constraints check 192, a check passed decision block 194, a return zero (0) result 195, a return error code result 196, and an MOF notification 198. The database application 152 also includes a trigger result equals zero (0) decision block 200, a commit result 202, and an abort result 204.

The database 35 receives the update request 182 and generates a trigger 184. The trigger 184 is detected by the application trigger handler 186 and relational database trigger handler 188. Trigger information is communicated to the server network management application 28 via the local transport bus 180. The database trigger attribute server implementation 190 receives the trigger information and performs a constraints check 192. Next, the server network management application 28 uses the check passed decision block 194 to determines if the check passed. If the check passed, the return zero (0) result is communicated to the database application 152 via the local transport bus 180 and the MOF notification 198 is provided. If the check did not pass, the return error code result is communicated to the database application 152 via the local transport bus 180.

The trigger result equals zero (0) decision block receives the results of the constraints check. If the trigger result equals zero (0) (i.e., check passed), the commit result 202 is communicated to the database 35. If the trigger result does not equal zero (0) (i.e., check did not pass), the abort result 204 is communicated to the database 35.

DataBlitz, for example, allows applications to define triggers for following database operations: 1) create data record, 2) update data record, and 3) delete data record. The database management code generator 50 (FIG. 6) can generate trigger definitions for application, when the “-t” option is used in a command for initiating code generation. The generated trigger definitions are provided in a file named “Trigger.ddl.”

The following programming steps set up the handling for the database trigger: 1) run the database management code generator with the “-t” option to generate trigger definitions for the database and install the triggers in the database, 2) instantiate an instance of DbTriggerAttributeServerImp1, for example, as a trigger server object in the data server process to serve the CORBA calls coming from the trigger handler, 3) publish the trigger server object reference, set the listening port number for the trigger server object, and write a simple trigger handle function, for example, handleBlzTrigger( ),that sets up an application-specific CORBA channel and invokes a generic trigger handle function, for example, BlzRelTriggerHandler::handleTrigger( ).

The following code provides an example of the second step for setting up database trigger handling:

```
DbTriggerAttributeServerImpl* triggerImpl =
  new DbTriggerAttributeServerImpl(
PersInitializer::getDB( ) );
RUBY_TIE_DEF(AttributeServer,AttributeServerImpl)*
triggerServer =
  RUBY_CORBA_NEW RUBY_TIE_DEF(AttributeServer,
  AttributeServerImpl)(new
AttributeServerImpl(triggerImpl) );
```

The following code provides an example of the third step for setting up database trigger handling:

CORBA: :object* triggerAs =
RubyPoaSpecific: :registerObjRefWithPoa(
triggerServer, nullServerId, “AttributeServer1” );
IorSender: :processIorRequests( 12000, triggerAs );

The following code provides an example of the fourth step for setting up database trigger handling:

```
extern “C” {
int handleBlzTrigger( const BlzTrans& tid,
    BlzTupleHdl& oldImage, BlzTupleHdl& newImage,
    const BlzTrigParams& params )
{
  // Reference the User Case section for the example
of trigger function
  ...
  int res = BlzRelTriggerHandler::handleTrigger( tid,
oldImage,
newImage, params);
    return res;
}
```

The function handleBlzTrigger( ) is called by DataBlitz any time data is changed in a database table if a trigger associated with the handleBlzTrigger function was installed with the table. To install triggers in the database, the following exemplary steps are used before bringing up any DataBlitz processes: 1) modify variables in the sys.rc file in the following manner: a) USE_SQL_SERVER=Yes (to bring up SQL server) and b) SQL_PORT_ID=28000 (port used by SQL server to listen to client requests), 2) compile the trigger handle function of the application and link it with the RAC library, for example, libRAC.so, to the trigger library named lib<schema name>[index].so, , for example, if a schema name is given in the MODL *.opt file for the application, or to the trigger library named libblzuser[index].so, for example, if there no schema name is given in the *.opt file, i.e. default schema is used (the [index] parameter is an optional integer in the range of two through five, inclusive), and 3) copy the trigger library to $BLZ_DBPATH/user, for example.

The following exemplary steps are used to bring up the database and create a schema: 1) run DataBlitz a script if a database trigger will be used (e.g., . $BLZ_ROOT/sq1/scripts/setup_env.ksh), 2) bring up the database server processes using the following commands: a) cd $BLZ_DBPATH and b) $BLZ_ROOT/bin/datablitz -q CREAT TRUNC&, 3) create the schema in the database using the script dbInstall.sh using the following commands: a) cd <directory where files dbinstall.sh, runRe1ddl.sh, DbGen.ddl and Trigger.ddl are located> and b) dbInstall.sh or, if triggers are used, dbInstall.sh -t, and 4) create other application defined triggers in the database using the following command: a) runRe1ddl.sh <re1ddl command file for application>.

One way to initialize the data server is to call the RAC-generated static function named PersInitializer::init( ), for example. This function performs the following steps for data server: 1) open the connection with the database process and connect to the schema specified in *.opt file associated with the application. or connect to the default schema, if no schema name is specified in the *.opt file, 2) initialize database queries for run time optimization, 3) initialize all instances of managed object adaptors for all persistence managed classes listed in the collection-mo-list in *.opt file, and 4) load all persistence managed objects from the database and build the object tree. If this function returns a zero (0), the data server is ready to provide persistence services; otherwise the data server should stop.

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

We claim:

1. A method of developing one or more application programs that cooperate to manage a distributed system comprising one or more servers, wherein at least one application program is associated with each server, the method including the steps:
a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system;
b) parsing the one or more resource definition language files to ensure conformity with the object-oriented resource definition language and creating an intermediate representation of the distributed system from the one or more conforming resource definition language files;
c) processing the intermediate representation of the distributed system to form one or more programming language classes, one or more database definition files, and one or more script files;
d) providing a reusable asset center framework to facilitate development of the one or more application programs, the reusable asset center including a data management framework that provides creation, deletion, modification, and browsing functions in conjunction with the one or more managed objects and a database for storing data associated with the one or more managed objects; and
e) building the one or more application programs from at least the one or more programming language classes, one or more database definition files, one or more script files, and the reusable asset framework.

2. The method as set forth in claim 1 wherein the distributed system is a network.

3. The method as set forth in claim 2 wherein the network is a telecommunication network.

4. The method as set forth in claim 1 wherein the data management framework loads at least one of the one or more managed objects with data from the database.

5. The method as set forth in claim 1 wherein the data management framework provides customized views of data associated with selected managed objects from the database.

6. The method as set forth in claim 1 wherein the data management framework includes at least one of a persistence attribute server class, a managed object handle class, a managed object adaptor, a managed object view subsystem, and a view notification class.

7. The method as set forth in claim 1 wherein the data management framework includes data access classes.

8. The method as set forth in claim 7 wherein the data access classes include at least one of a relational database trigger handler class, a database trigger attribute server implementation class, a managed object handle class, a resource definition language collection managed object adaptor class, a persistence attribute server local class, and a relational database collection data management class.

9. The method as set forth in claim 7 wherein the data management framework also includes view management classes.

10. The method as set forth in claim 9 wherein the view management classes include at least one of a managed object view class, a managed object view factory class, managed object view server interface classes, a managed object view server implementation class, view notifier classes, a view modifier managed object adaptor class, and a view server map class.

11. The method as set forth in claim 10 wherein the managed object view server interface classes include at least one of a managed object view server implementation class and a managed object view server local class.

12. The method as set forth in claim 10 wherein the view notifier classes include at least one of a local view notifier class and an event management framework view notifier class.

13. The method as set forth in claim 1 wherein the reusable asset center also includes a persistence framework that cooperates with the data management framework to selectively provide persistent data in the database for the one or more managed objects.

14. The method as set forth in claim 13 wherein the persistence framework includes at least one of a database class, a database factory class, a database table class, a database table iterator class, a database table list class, a database index class, a database query class, a transaction class, a query initializer class, and a persistence initializer class.

15. The method as set forth in claim 13 wherein the persistence framework includes a layered architecture.

16. A method of developing one or more application programs in operative communication to manage a network including one or more servers, wherein at least one application program is associated with each server, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network created in the parsing step includes a parse tree;
c) processing the parse tree to form one or more programming language classes, wherein the one or more programming language classes formed include at least one of one or more system classes, one or more module classes, one or more managed object classes, and one or more composite attribute classes;
d) providing a reusable asset center framework to facilitate development of the one or more application programs, the reusable asset center including a persistence framework that provides persistent data storage functions in conjunction with the one or more managed objects and a database for storing data associated with the one or more managed objects; and
e) building the one or more application programs from at least the one or more programming language classes and the reusable asset framework.

17. The method as set forth in claim 16 wherein the reusable asset center also includes a data management framework that provides creation, deletion, modification, and browsing functions in conjunction with the one or more managed objects and the database.

18. The method as set forth in claim 17 wherein the data management framework loads at least one of the one or more managed objects with data from the database.

19. The method as set forth in claim 17 wherein the data management framework provides customized views of data associated with selected managed objects from the database.

20. The method as set forth in claim 17 wherein the data management framework includes at least one of a persistence attribute server class, a managed object handle class, a managed object adaptor, a managed object view subsystem, and a view notification class.

21. The method as set forth in claim 17 wherein the data management framework includes data access classes and view management classes.

22. The method as set forth in claim 16 wherein the persistence framework includes at least one of a database class, a database factory class, a database table class, a database table iterator class, a database table list class, a database index class, a database query class, a transaction class, a query initializer class, and a persistence initializer class.

23. The method as set forth in claim 16 wherein the persistence framework includes a layered architecture.

24. The method as set forth in claim 23 wherein the layered architecture includes a persistence abstract layer in communication with the data management framework, a database implementation-specific layer in communication with the database, and an application-specific layer in communication with the persistence abstract layer and database implementation-specific layer.

25. The method as set forth in claim 24 wherein the persistence abstract layer includes at least one of a database class, a database factory class, a database table class, a database table iterator class, a database table list class, a database index class, a database query class, a transaction class, a mapping class, a POID class, a POID factory class, and a POID factory finder class.

26. The method as set forth in claim 24 wherein the database implementation-specific layer includes at least one of a relational database table class, a relational database table iterator class, a relational server database class, a relational database factory class, a transaction implementation class, a relational POID class, a relational POID factory class, and a database table persistence array implementation class.

27. The method as set forth in claim 24 wherein the application-specific layer includes at least one of a database query class for each managed object in the corresponding database, a database index class for each managed object in the corresponding database, a managed object handle class for each managed object in the corresponding database, a query initializer class, and a persistence initializer class.

28. A method of developing an application program to manage a network, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network includes object meta-data;
c) processing the object meta-data to form one or more programming language classes, one or more database definition files, and one or more script files, wherein the one or more programming language classes formed include at least one of an index class and a query class;
d) providing a reusable asset center framework to facilitate development of the application program, the reusable asset center including a data management framework that provides creation, deletion, modification, and browsing functions in conjunction with the one or more managed objects and a database for storing data associated with the one or more managed objects and a persistence framework that cooperates with the data management framework to selectively provide persistent data in the database for the one or more managed objects; and
e) building the application program from at least the one or more programming language classes, one or more database definition files, one or more script files, and the reusable asset framework.

29. The method as set forth in claim 28 wherein the data management framework loads at least one of the one or more managed objects with data from the database.

30. The method as set forth in claim 28 wherein the data management framework provides customized views of data associated with selected managed objects from the database.

31. The method as set forth in claim 28 wherein the data management framework includes at least one of a persistence attribute server class, a managed object handle class, a managed object adaptor, a managed object view subsystem, and a view notification class.

32. The method as set forth in claim 28 wherein the data management framework includes data access classes and view management classes.

33. The method as set forth in claim 28 wherein the persistence framework includes at least one of a database class, a database factory class, a database table class, a database table iterator class, a database table list class, a database index class, a database query class, a transaction class, a query initializer class, and a persistence initializer class.

34. The method as set forth in claim 28 wherein the persistence framework includes a layered architecture.

35. The method as set forth in claim 34 wherein the layered architecture includes a persistence abstract layer in communication with the data management framework, a database implementation-specific layer in communication with the database, and an application-specific layer in communication with the persistence abstract layer and database implementation-specific layer.
